(19) United States
(12) Patent Application Publication
(10) Pub. No.: US 2024/0014433 A1
(43) Pub. Date: Jan. 11, 2024

(54) Method of Manufacturing an Electrode Assembly and Manufacturing Apparatus Thereof

(71) Applicant: LG Energy Solution, Ltd., Seoul (KR)

(72) Inventors: Eunji Song, Daejeon (KR); Ki Beom Park, Daejeon (KR); Euiseob Song, Daejeon (KR); Minha Yee, Daejeon (KR); Zhenghua Li, Daejeon (KR); Hyojoon Lee, Daejeon (KR)

(73) Assignee: LG Energy Solution, Ltd., Seoul (KR)

(21) Appl. No.: 18/036,562

(22) PCT Filed: Sep. 28, 2022
(86) PCT No.: PCT/KR2022/014599

§ 371 Date: May 11, 2023

(30) Foreign Application Priority Data
Sep. 29, 2021 (KR) 10-2021-0128689

(51) Int. Cl. H01M 10/04

(52) U.S. Cl. CPC H01M 10/0431; H01M 10/0409

(57) ABSTRACT

An electrode assembly is manufactured in which unit cells are wound with a separation film. Unit cells are mounted on an upper surface of the separation film to prepare an array body. One end of each of the unit cells where tabs of the unit cells are formed, another end of each of the unit cells, which are in the upper and lower portions of a direction parallel to a longitudinal direction of the separation film and parallel to a winding direction of the array body, and the separation film positioned at a corresponding location thereof. The heat-treated unit cells are wound with the separation film. An apparatus manufactures the electrode assembly.

### CROSS-REFERENCE TO RELATED APPLICATIONS

The present application is a national phase entry under 35 U.S.C. § 371 of International Application No. PCT/KR2022/014599 filed on Sep. 28, 2022, and now published as International Publication No. WO 2023/055094 A1, which claims priority from Korean Patent Application No. 10-2021-0128689 filed on Sep. 29, 2021, all of which are hereby incorporated herein by reference.

### FIELD

The present disclosure relates to a method of manufacturing an electrode assembly and a manufacturing apparatus thereof.

### BACKGROUND

Due to the rapid increase in the use of fossil fuels, the demand for the use of alternative energy or clean energy is increasing, and as part thereof, the fields that are being studied most actively are the fields of power generation and power storage using electrochemistry.

At present, a secondary battery is a representative example of an electrochemical device that utilizes such electrochemical energy, and the range of use thereof tends to be gradually expanding.

In recent years, as mobile devices, such as portable computers, portable phones, and cameras, have been increasingly developed, the demand for secondary batteries has also sharply increased as an energy source for the mobile devices. Among such secondary batteries is a lithium secondary battery exhibiting a high energy density and a high voltage, a long cycle lifespan, and a low self-discharge rate, in which much research has been carried out and which is now commercialized and widely used.

In addition, as interest in environmental issues grows, studies are frequently conducted on an electric vehicle, a hybrid electric vehicle, etc. which can replace a vehicle using fossil fuels such as a gasoline vehicle and a diesel vehicle, which are one of the main causes of air pollution. Although a nickel metal hydride secondary battery is mainly used as a power source for the electric vehicle and the hybrid electric vehicle, research on the use of a lithium secondary battery having high energy density and discharge voltage is actively being conducted, a part of which are in the commercialization stage.

This lithium secondary battery has a structure in which an electrode assembly is built into a secondary battery case, and the electrode assembly is structurally classified into a jelly roll-type electrode assembly manufactured by winding a cathode sheet, an anode sheet, and a separation film, a stacked electrode assembly that stacks a unit cathode, a unit anode, and a separator, a stack/folding type electrode assembly that winds unit cells such as bi-cells, full-cells or mono-cell with a separator film, and a stacked/laminated type electrode assembly that laminates the unit cells. At this time, during the folding process of winding the unit cells with a separation film, the stack/folding type electrode assembly has a problem that as the unit cell is mounted on the separation film and then simply wound, a non-bonded region between the folding surface and the unit cell is increased, the interfacial resistance in the non-bonded region is increased, and thus lithium is deposited.

Particularly, the electrode included in the unit cells has a flat portion in which the thickness of the active material layer is constant and an inclined portion whose thickness gradually decreases from both ends thereof, wherein the non-bonded region is more pronounced at the inclined portion.

Therefore, the lithium deposited therefrom threatens the safety of the secondary battery, which causes a problem that cycle characteristics are remarkably deteriorated.

Therefore, there is an urgent need to develop a technique for manufacturing an electrode assembly for a secondary battery that can solve these problems.

### SUMMARY OF THE DISCLOSURE

The present disclosure is designed to solve the above-mentioned problems, and an object of the present disclosure is to provide a method of manufacturing an electrode assembly and a manufacturing apparatus thereof that can suppress lithium deposition at both ends where the electrode assembly tabs are formed, thus improving the safety and cycle characteristics of a secondary battery.

Terms or words used in the present specification and claims should not be construed as limited to ordinary or dictionary terms, and the present disclosure should be construed with meanings and concepts that are consistent with the technical idea of the present disclosure based on the principle that the inventors may appropriately define concepts of the terms to appropriately describe their own disclosure in the best way.

Hereinafter, according to one embodiment of the present disclosure, there is provided a method of manufacturing an electrode assembly in which unit cells are wound with a separation film, the method comprising the steps of:
(a) mounting unit cells on the upper surface of the separation film to prepare an array body;
(b) heat-treating one end of each of the unit cells where tabs of the unit cells are formed, another end of each of the unit cells, and the separation film positioned at a corresponding location thereof, which are positioned in the upper and lower portions of a direction parallel to a longitudinal direction of the separation film and parallel to a winding direction of the array body; and
(c) winding the heat-treated unit cells with the separation film.

In step (a), the unit cells may be mounted on the upper surface of the separation film, so that the electrode tabs having the same polarity are located upward and downward at the same position after winding.

Further, the heat treatment of step (b) may be performed by heating or hot air, and the heat treatment of step (b) may be performed at 50° C. to 200° C.

When specifically considering the region where the heat treatment is performed, the electrode included in the unit cells has a flat portion where the thickness of the active material layer is constant and an inclined portion where the thickness of the active material layer decreases from both ends of the flat portion, and
one end and the other end where tabs of the unit cells are formed may include a region corresponding to the inclined portion.

In one specific embodiment, the winding speed of step (c) may be 5 rpm to 30 rpm.

The heat treatment in step (b) and the winding in step (c) may be performed continuously, and thus, the heat treatment time is affected by the winding speed.

Meanwhile, the electrode assembly may include a single-sided electrode in which an active material layer is formed only on the inner side of the electrode located at the outermost portion in a wound state.

Each of the unit cells may be a bi-cell, a full-cell, or a mono-cell.

According to another embodiment of the present disclosure, there is provided an apparatus of manufacturing an electrode assembly in which unit cells are wound with a separation film, the apparatus comprising:
a winder that winds an array body in which the unit cells are mounted on the upper surface of the separation film, and
heaters being configured for heat-treating one end of each of the unit cells where tabs of the unit cells are formed, another end of each of the unit cells, and the separation film positioned at a corresponding location thereof, which are positioned in the upper and lower portions of a direction parallel to a longitudinal direction of the separation film and parallel to a winding direction of the array body.

Wherein, the heater may be of a heating type or a hot air type.

The heater may be formed in a portion wholly covered the unit cells which are mounted on the upper surface of the separation film.

The winder may be located on one side of the heater.

### BRIEF DESCRIPTION OF THE DRAWINGS

FIG. 1 is a schematic diagram of the electrode assembly manufacturing apparatus according to an embodiment of the present disclosure;

FIG. 2 is a schematic side view of the unit cell of the present disclosure; and

FIG. 3 is a schematic cross-sectional diagram of the electrode assembly of the present disclosure.

### DETAILED DESCRIPTION

Hereinafter, preferred embodiments of the present disclosure will be described in detail with reference to the accompanying drawings.

The terms and words used in the present specification and claims should not be interpreted as being limited to typical meanings or dictionary definitions, but should be interpreted as having meanings and concepts relevant to the technical scope of the present disclosure based on the rule according to which an inventor can appropriately define the terms and words as terms for describing most appropriately the best method he or she knows for carrying out the invention. Accordingly, the embodiments described herein and the configurations shown in the drawings are only most preferable embodiments of the present disclosure and do not represent the technical idea of the present disclosure, so it should be appreciated that there may be various equivalents and modifications that can replace the embodiments and the configurations at the time at which the present application is filed, and the scope of the present invention is not limited to the embodiments described below.

According to one embodiment of the present disclosure, there is provided a method of manufacturing an electrode assembly in which unit cells are wound with a separation film, the method comprising the steps of:
(a) mounting unit cells on the upper surface of the separation film to prepare an array body;
(b) heat-treating one end of each of the unit cells where tabs of the unit cells are formed, another end of each of the unit cells, and the separation film positioned at a corresponding location thereof, which are positioned in the upper and lower portions of a direction parallel to a longitudinal direction of the separation film and parallel to a winding direction of the array body; and
(c) winding the heat-treated unit cells with the separation film.

According to another embodiment of the present disclosure, there is provided an apparatus of manufacturing an electrode assembly in which unit cells are wound with a separation film, the apparatus comprising:
a winder that winds an array body in which the unit cells are mounted on the upper surface of the separation film, so that the electrode tabs having the same polarity are located upward and downward at the same position, after winding, and
heaters being configured for heat-treating one end of each of the unit cells where tabs of the unit cells are formed, another end of each of the unit cells, and the separation film positioned at a corresponding location thereof, which are positioned in the upper and lower portions of a direction parallel to a longitudinal direction of the separation film and parallel to a winding direction of the array body.

Now, an electrode assembly manufacturing method and a manufacturing apparatus thereof according to the present disclosure will be described together based on the schematic diagram of the electrode assembly manufacturing apparatus.

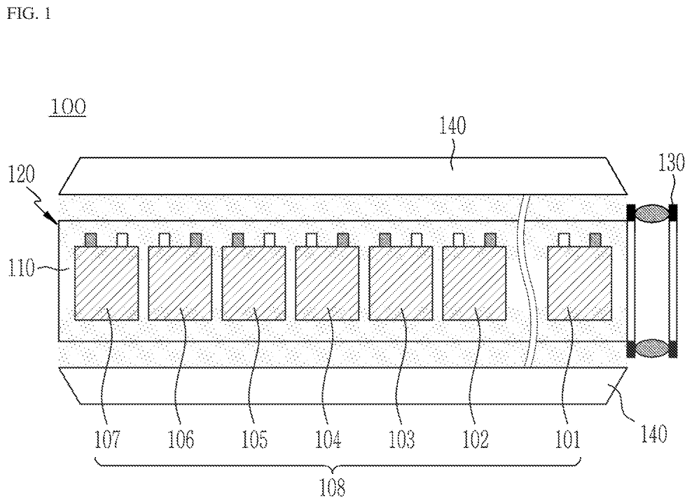

Specifically, FIG. 1 schematically shows an electrode manufacturing apparatus for a secondary battery according to an embodiment of the present disclosure.

Referring to FIG. 1, an electrode assembly manufacturing apparatus 100 for a secondary battery according to the present disclosure includes a winder 130 that winds an array body 120 in which unit cells 108: 101, 102, 103, 104, 105, 106 and 107 are mounted on the upper surface of a separation film 110, and heater 140 that are located at the upper and lower portions in the longitudinal direction of the separation film 110 parallel to the winding direction of the array body 120 and heat-treats one end and the other end where tabs of the unit cells are formed, and the separation film 110 corresponding thereto.

First, according to an embodiment of the present disclosure, the electrode assembly of the present disclosure is manufactured by arranging a plurality of unit cells 108 on the separation film 110 to prepare the array body 120.

At this time, the unit cells 108 are wound and then arranged so that the electrode tabs having the same polarity are located upward and downward at the same position.

Each of the unit cells 108 may be a bi-cell in which electrodes having the same polarity are located at both ends, a full-cell in which electrodes having different polarity are located at both ends, or a mono-cell including one electrode.

For example, the bi-cell may have a structure of anode/separator/cathode/separator/anode, the full-cell may have a structure of anode/separator/cathode, and the mono-cell may have a structure in which any one electrode of a cathode or an anode and a separator are stacked.

However, it is needless to say that the unit cells 108 are wound and then should be arranged so as to have a stacked structure in which cathode and anode are alternately arranged.

Meanwhile, the electrodes included in the unit cells 108 are configured such that an inclination is generated at one end and the other end where tabs are formed due to application of the electrode active material slurry during the manufacturing process of the electrode.

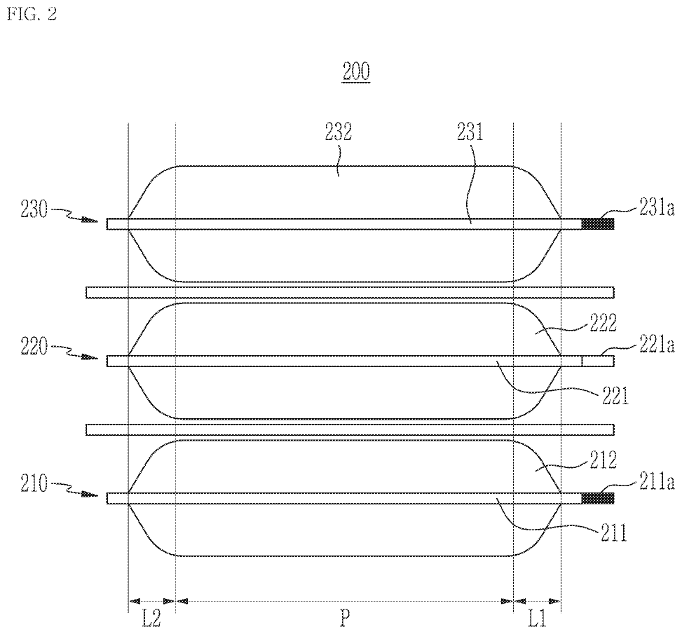

In order to specifically explain this, FIG. 2 schematically shows a side view of the unit cell of the present disclosure.

Referring to FIG. 2, the unit cell 200 is composed of a plurality of electrodes 210, 220 and 230. FIG. 2 shows a bi-cell consisting of three electrodes 210, 220 and 230, but is not so limited thereto.

The electrodes 210, 220 and 230 have a structure in which active material layers 212, 222 and 232 are formed on current collectors 211, 221 and 231, respectively, and electrode tabs 211a, 221a and 231a are formed on one side of the current collectors 211, 221 and 231, respectively.

Here, considering the active material layers 212, 222 and 232, the active material layers 212, 222 and 232 have a flat portion P where the thickness of active material layers 212, 222 and 232 are constant, and inclined portions L₁ and L₂ where the thickness of the active material layers 212, 222 and 232 decreases from both ends of the flat portion P. Specifically, the active material layer has an inclined portion L₁ on one end side of the tab in the direction in which the tab is formed and an inclined portion L₂ on the other end side corresponding thereto.

Thus, the active material layers of the electrodes 210, 220 and 230 forming the unit cell 200 have the inclined portions L₁ and L₂, so that when the unit cell 200 is wound with a separation film, the inclined portion L₁ of one end where a tab is formed and the inclined portion L₂ of the other end corresponding thereto are spaced apart from the separation film to generate a space and not bonded, and thus, the deposition of lithium often occurs in the region.

However, referring to FIG. 1 again, in the present disclosure, a process is performed in which the array body 120 in which the unit cells 108 are mounted on the separation film 110 is heat-treated together with one end and the other end in which the tabs are formed in the unit cells 108, and the separation film 110 corresponding thereto.

At this time, one end and the other end where tabs of the unit cells 108 subjected to heat treatment are formed may be regions including regions corresponding to the inclined portions of the electrodes.

The heat treatment is performed by heaters 140 located at the upper and lower portions in the longitudinal direction of the separation film 110, wherein the heat treatment may be performed by heating or hot air, and therefore, the heater 140 may be a heating type or hot air type device.

Moreover, the heat treatment may be performed at 50° C. to 200° C.

If the heat treatment is performed at too low a temperature outside the above range, the bonding effect intended by the present disclosure cannot be sufficiently obtained, and if the heat treatment is performed at too high a temperature, deformation of the active material layer and deformation of the separation film may be occurred, which is not preferable.

Meanwhile, after the heat treatment, the unit cells 108 are wound with the separation film 110.

At this time, the heat treatment time may be affected by the winding speed performed after the heat treatment.

Specifically, the winder 130 for winding the array body 120 may be located on one side of the heater 140, whereby the heat treatment of step (b) and the winding of step (c) may be performed continuously. Therefore, the heat treatment time can be affected by the winding speed.

At this time, the winding speed of step (c) may be 5 rpm to 30 rpm.

If the winding speed is too fast outside the above range, a sufficient heat treatment effect cannot be obtained, and if the winding speed is too slow, overheating may occur, which is not preferable.

Further, the heater 140 for performing the heat treatment is not limited in size, and the unit cells 108 may be formed in a portion mounted on the upper surface of the separation film 110, so that the unit cells 108 can be sufficiently heat-treated.

Specifically, when the heat treatment is performed in this way, the heat treatment time of the unit cell may be 3 seconds to 20 seconds.

If the heat treatment time is outside the above range, a sufficient heat treatment effect cannot be obtained or, conversely, overheating may occur, which is not preferable.

Meanwhile, the electrode assembly manufactured in this way may be a single-sided electrode in which an active material layer is formed only on the inner side of the electrode located at the outermost portion in a wound state.

Therefore, the electrode facing the separation film 110 in the two unit cells 106 and 107 at the winding end point of FIG. 1 may be a single-sided electrode.

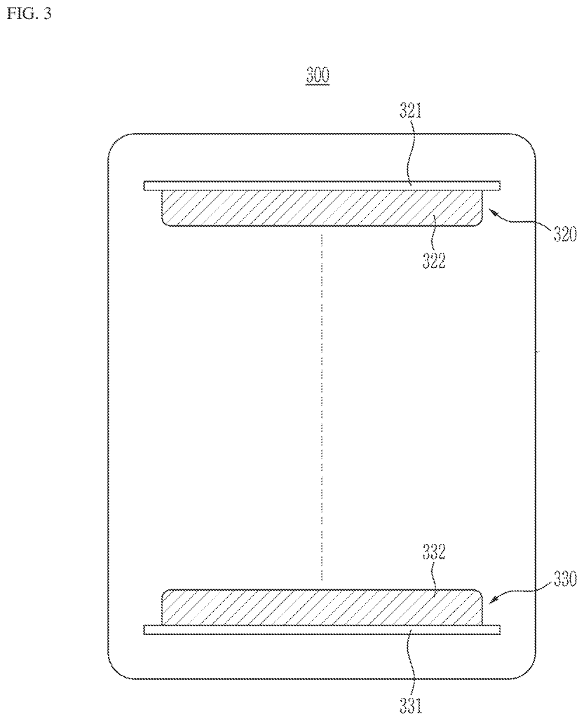

In order to explain this more clearly, a cross-sectional view of the electrode assembly in a wound state is shown in FIG. 3.

Referring to FIG. 3, the electrode assembly 300 has a structure in which unit cells are wound with a separation film 310. At this time, respective electrodes 320 and 330 included in the unit cells 106 and 107 present at the outermost portion is a single-sided electrode in which active material layers 322 and 332 are respectively formed only on the inner side of an electrode assembly 300 on current collectors 321 and 331.

Specifically, the electrode 320 located on the upper portion is formed with the active material layer 322 only on the lower surface of the current collector 321, and the electrode 330 located at the lower portion is formed with an active material layer 332 only on the upper surface of the current collector 331.

When the electrodes located at the outermost portion are single-sided electrodes, there is no waste of the active material layer, and the overall thickness of the electrode assembly is reduced, which is thus more preferable.

A person having ordinary knowledge in the field to which the present disclosure belongs can make various applications and modifications departing the sprit and scope of the present disclosure based on the above contents.

### DESCRIPTION OF REFERENCE NUMERALS

100: electrode assembly manufacturing apparatus
110: separation film
101, 102, 103, 104, 105, 106, 107: unit cell
108: unit cells
120: array body
130: winder
140: heater
200: unit cell
210, 220, 230, 320, 330: electrode
211, 221, 231, 321, 331: current collector
211a, 221a, 231a: electrode tab
212, 222, 232, 322, 332: active material layer
300: electrode assembly.

According to the present disclosure, when one end formed with tabs that do not adhere well to the electrode assembly, and the other end corresponding thereto are heat-treated before winding in a state in which the unit cells are arranged on the separation film, a non-bonded region between the separation film and the unit cells can be minimized and thus, the deposition of lithium can be minimized, thereby improving the safety and cycle characteristics of a secondary battery including the same.

1. A method of manufacturing an electrode assembly, the method comprising the steps of:
(a) mounting unit cells on the upper surface of a separation film to prepare an array body;
(b) heat-treating one end of each of the unit cells where tabs of the unit cells are formed, another end of each of the unit cells, and the separation film positioned at a corresponding location thereof, which are positioned in the upper and lower portions of a direction parallel to a longitudinal direction of the separation film and parallel to a winding direction of the array body; and
(c) winding the heat-treated unit cells with the separation film.

2. The method of manufacturing an electrode assembly according to claim 1, wherein:
in step (a), the unit cells are mounted on the upper surface of the separation film so that the electrode tabs having the same polarity are located upward and downward at the same position after winding.

3. The method of manufacturing an electrode assembly according to claim 1, wherein:
the heat-treating of step (b) is performed by heating or hot air.

4. The method of manufacturing an electrode assembly according to claim 1, wherein:
the heat-treating of step (b) is performed at 50° C. to 200° C.

5. The method of manufacturing an electrode assembly according to claim 1, wherein:
the electrode included in the unit cells has a flat portion where the thickness of the active material layer is constant and an inclined portion where the thickness of the active material layer decreases from both ends of the flat portion, and
the one end and the other end where tabs of the unit cells are formed include a region corresponding to the inclined portion.

6. The method of manufacturing an electrode assembly according to claim 1, wherein:
the winding speed of step (c) is 5 rpm to 30 rpm.

7. The method of manufacturing an electrode assembly according to claim 1, wherein:
the heat-treating in step (b) and the winding in step (c) are performed continuously.

8. The method of manufacturing an electrode assembly according to claim 1, wherein:
the electrode assembly includes a single-sided electrode in which an active material layer is formed only on the inner side of the electrode located at the outermost portion in a wound state.

9. The method of manufacturing an electrode assembly according to claim 1, wherein:
each of the unit cells is a bi-cell, a full-cell, or a mono-cell.

10. An apparatus of manufacturing an electrode assembly in which unit cells are wound with a separation film, the apparatus comprising:
a winder that winds an array body in which the unit cells are mounted on the upper surface of the separation film, and
heaters being configured for heat-treating one end of each of the unit cells where tabs of the unit cells are formed, another end of each of the unit cells, and the separation film positioned at a corresponding location thereof, which are positioned in the upper and lower portions of a direction parallel to a longitudinal direction of the separation film and parallel to a winding direction of the array body.

11. The apparatus of manufacturing an electrode assembly according to claim 10, wherein:
the heater is of a heating type or a hot air type.

12. The apparatus of manufacturing an electrode assembly according to claim 10, wherein:
the heater is formed in a portion wholly covered the unit cells which are mounted on the upper surface of the separation film.

13. The apparatus of manufacturing an electrode assembly according to claim 10, wherein:
the winder is located on one side of the heater.
